(19) United States
(12) Patent Application Publication
(10) Pub. No.: US 2021/0195873 A1
(43) Pub. Date: Jul. 1, 2021

(54) SMART PET CARE SYSTEM

(71) Applicant: KOREA SAFETY RISK MANAGEMENT, Dongan-Gu, Gyeonggi-do (KR)

(72) Inventors: Donghag RHO, Anyang-Si, Gyeonggi-do (KR); Kijun CHUN, Anyang-si, Gyeonggi-do (KR); Jungho SON, Bucheon-Si, Gyeonggi-do (KR)

(73) Assignee: KSRM Co., Ltd., Anyang-Si, Gyeonggi-do (KR)

(21) Appl. No.: 17/258,157

(22) PCT Filed: Feb. 18, 2019
(86) PCT No.: PCT/KR2019/001913

§ 371 Date: Jan. 6, 2021

(30) Foreign Application Priority Data
Aug. 6, 2018 (KR) 10-2018-0091366

(51) Int. Cl. A01K 29/00; A01K 5/02; A01K 7/02; G05B 15/02

(52) U.S. Cl. CPC A01K 29/005; G05B 15/02; A01K 7/02; A01K 5/02

(57) ABSTRACT

A smart pet care system includes: a pet care device adapted to feed and water a pet and to transmit status information related to the pet to an external device; a smartphone controlling the pet care device based on input information from a user; and a management server transmitting care information for caring for the pet to the smartphone based on the status information and preset setting information.

### FIELD

The present invention relates to a smart pet care system. More particularly, the present invention relates to a smart pet care system which can provide care for a pet by monitoring a status of the pet.

### BACKGROUND

In recent years, the number of single people has increased. In general, people living a long single life experience deep loneliness.

For single people, having a pet provides resolution of loneliness.

However, most pet owners work at a company and thus cannot spend much time with their pet.

Pets spending much time alone at home often suffer from impairment in social interaction, depression, or the like.

Further, problems caused thereby act as a stressor for both a pet and an owner of the pet.

In particular, visiting a veterinary clinic, which is not covered by insurance, puts extra stress on a pet owner.

As an example of the related art to solve such a problem, Korean Patent Publication No. 10-2014-0146806 discloses a pet management apparatus. However, the pet management apparatus only has a function to transmit pre-input or preset simple information, such as an owner's voice, to a pet.

Therefore, such a typical pet management apparatus has a problem of difficulty providing safe care for a pet through real-time monitoring of the status of the pet.

### SUMMARY

Embodiments of the present invention provide a smart pet care system which can feed and water a pet using a care application installed in a smartphone while providing stable care for the pet based on information obtained by monitoring the status of the pet.

In accordance with an aspect of the present invention, there is provided a smart pet care system including: a pet care device disposed inside a building to feed and water a pet and to transmit status information related to the pet to an external device via wireless communication networks; a smartphone wirelessly communicating with the pet care device to control the pet care device based on input information from a user and to display the status information such that the user checks a status of the pet; and a management server electronically connected to the pet care device and the smartphone to transmit care information for caring for the pet to the smartphone based on the status information received from the pet care device and preset setting information.

The smartphone may include a microprocessor in which a care application for controlling the pet care device is embedded.

The care application may include a monitoring menu for viewing images of the pet, a feeding/watering setting menu for setting feeding/watering amounts and times in advance, a general application setting menu for setting the care application, and a notification inbox menu for displaying the care information or the status information.

The monitoring menu may include a video call menu for making a video call with the pet; and an arbitrary feeding/watering menu for inputting a signal for feeding or watering the pet based on the images of the pet.

The care information may include a safety index quantifying a degree of safety of the pet based on the status information.

The care application may further include a pet diary menu for keeping a pet diary in the form of at least one of a photograph and a video based on the status information and a feeding/watering statistics menu for displaying feeding/watering-related statistical data over a certain period of time.

The pet care device may include: an IP camera acquiring image information including images related to the pet; a microphone acquiring sound information including sounds of the pet; a speaker outputting a user's voice received from the smartphone; and a main body provided with the IP camera, the microphone, and the speaker.

The main body may further include: a main body case having a space defining portion defining a food storage space containing pet food and a water storage space partitioned from the food storage space and containing water; a water bowl integrally formed with the main body case and filled with the water discharged from the water storage space; a food bowl integrally formed with the main body case and filled with the pet food discharged from the food storage space; a water supply unit disposed under the space defining portion to supply the water from the water storage space to the water bowl; and a food supply unit disposed under the space defining portion to supply the pet food from the food storage space to the food bowl.

The food supply unit may include: a food guide portion disposed between the food storage space and the food bowl to be inclined downward; a food transfer member moving the pet food introduced into the food guide portion to the food bowl; and a rotation drive unit rotating the food transfer member.

The food guide portion may be formed at one side thereof with an inlet through which the pet food is introduced into the food guide portion from the food storage space and may be formed at the other side thereof with an outlet through which the pet food introduced through the inlet is discharged to the food bowl.

The food transfer member may include a shaft coupled to the rotation drive unit and multiple rotary vanes coupled to the shaft to move the pet food introduced through the inlet through rotation thereof.

The food supply unit may further include an elastic member covering edges of the multiple rotary vanes to protect the multiple rotary vanes.

The pet care device may further include: a first sensor disposed in the water bowl to detect a water level in the water bowl; and a second sensor disposed in the food bowl to detect a pet food level in the food bowl.

The main body may further include: a cover disposed on a top of the main body case.

The cover may include a food storage space cover for opening/closing the food storage space, a water storage space cover for opening/closing the water storage space, a hinge portion to which the food storage space cover and the water storage space cover are hingedly coupled, and a stopper member restricting opening of the water storage space cover.

The hinge portion may include a first hinge portion formed at one side of the food storage space cover and a second hinge portion formed at one side of the water storage space cover and hingedly coupled to the first hinge portion.

The stopper member may include a stopper body rotatably disposed through the food storage space cover and a stopper protrusion protruding from a lower region of the stopper body in an outward radial direction of the stopper body.

When the stopper protrusion is positioned under the second hinge portion due to rotation of the stopper body, the water storage space cover is prevented from being opened due to interference caused by physical contact between the stopper protrusion and the second hinge portion.

The main body may further include: a base plate coupled to a lower end of the main body case; a mounting plate disposed at a distance above the base plate; and support legs connecting the base plate to the mounting plate.

The food supply unit and the water supply unit may be disposed on the mounting plate, wherein the food supply unit may be positioned above the food bowl with respect to the base plate and the water supply unit may be positioned above the water bowl with respect to the base plate.

The smart pet care system according to the present invention allows a user to monitor the status of a pet through the pet care device and to induce psychological stability of the pet even when the user is far away from the pet, thereby promoting mental health of the pet.

In addition, the smart pet care system according to the present invention can control feeding/watering operations through wireless communication between the smartphone and the pet care device, whereby, when a user is absent in a building where a pet resides, the user can feed and water the pet through remote control over the feeding/watering operations.

Effects of the present invention are not limited to the above effects and should be construed to include all effects conceivable from features of the present invention set forth in the following detailed description or the appended claims.

### DRAWINGS

FIG. 1 is a schematic diagram of a smart pet care system according to one embodiment of the present invention.

FIG. 2 is a view of a pet care device according to one embodiment of the present invention.

FIG. 3 is an exploded view of the pet care device according to the embodiment, showing main components thereof.

FIG. 4 is a bottom view of a cover of the pet care device according to one embodiment of the present invention.

FIG. 5 is a view of a water supply unit of the pet care device according to one embodiment of the present invention.

FIG. 6 is a view of a food supply unit of the pet care device according to one embodiment of the present invention.

FIG. 7 is a view of a display of a care application on a smartphone according to one embodiment of the present invention.

FIG. 8 is a view of detailed menus of the care application according to one embodiment of the present invention.

### DETAILED DESCRIPTION

Hereinafter, embodiments of the present invention will be described with reference to the accompanying drawings. It should be understood that the present invention is not limited to the following embodiments and may be embodied in different ways.

When an element or layer is referred to as being “on,” “connected to,” or “coupled to” another element or layer, it may be directly on, connected to, or coupled to the other element or layer or intervening elements or layers may be present. Moreover, the terms “comprises,” “comprising,” “includes,” and/or “including” when used in this specification, specify the presence of stated features, integers, steps, operations, elements, components, and/or groups thereof, but do not preclude the presence or addition of one or more other features, integers, steps, operations, elements, components, and/or groups thereof.

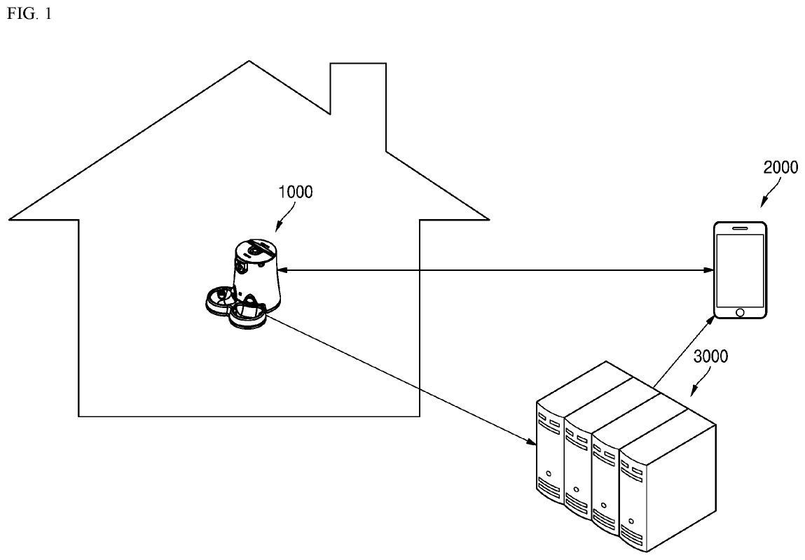

Referring to FIG. 1 to FIG. 8, a smart pet care system according to one embodiment of the present invention may include a pet care device 1000, a smartphone 2000, and a management server 3000.

The pet care device 1000 is disposed inside a building to feed and water a pet and to transmit status information related to the pet to external devices via wireless communication.

Here, the pet care device 1000 may be connected to the management server 3000 and the smartphone 2000, which are external devices described below, via wireless communication.

The pet care device 1000 may be operated based on input signals to the smartphone 2000.

More specifically, the pet care device 1000 may be installed in a room in which the pet resides.

Although the pet may be a dog or a cat, it will be understood that the present invention is not limited thereto and the pet may include various other animals.

The pet care device 1000 serves as a mediator to emotionally connect the pet to a user even when the user is away from the building.

By way of example, the pet care device 1000 may transmit/receive image data to/from the smartphone 2000, thereby allowing a video call between the pet and a user.

In addition, the pet care device 1000 may feed or water the pet and may transmit sound data of the pet to the smartphone 2000.

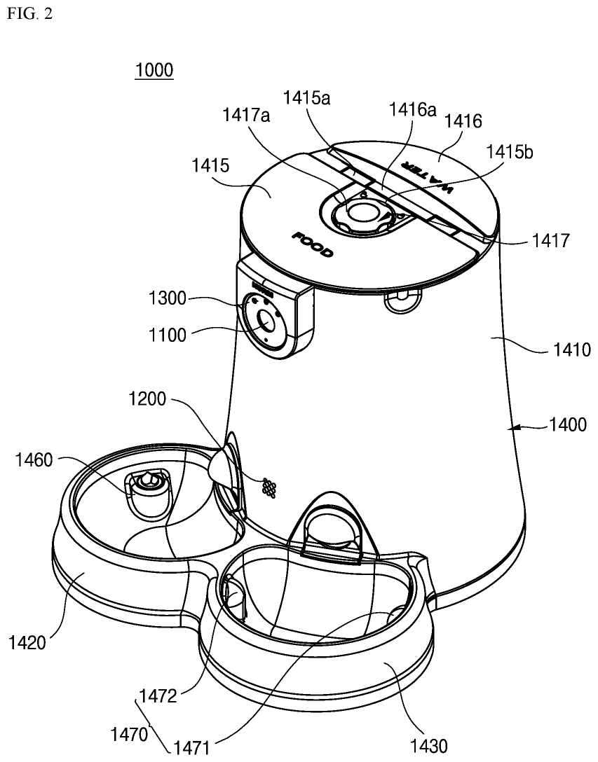

Referring to FIG. 2 to FIG. 5, the pet care device 1000 may include an IP camera 1100, a speaker 1200, a microphone 1300, and a main body 1400, and a main board 1500.

The main body 1400 may be provided with the IP camera 1100, the microphone 1300, and the speaker 1200.

The IP camera 1100 may acquire image information including images related to the pet.

More specifically, the IP camera 1100 may capture status information related to the pet. Here, the status information may include information related to a feeding or watering situation of the pet and information related to movement of the pet.

In addition, the IP camera 1100 may acquire image information related to an environment in the room and an intruder in the room.

The image data captured by the IP camera 1100 may be transmitted to the management server 3000 or the smartphone 2000 via a controller and a communication unit provided to the main board 1500.

The speaker 1200 may output a user's voice received from the smartphone 2000.

In addition to the user's voice, the speaker 1200 may also output audio content received from the smartphone 2000, such as music.

The microphone 1300 may acquire sound information including sounds of the pet. By way of example, the sound information may include sound-related status information, such as barks of the pet.

The sound information acquired by the microphone 1300 may be transmitted to the management server 3000 or the smartphone 2000 via the controller and the communication unit provided to the main board 1500.

Although not shown in the drawings, the pet care device 1000 may further include a display (not shown).

The display may display a user's image transmitted from the smartphone 2000 on a screen. Accordingly, the pet may gain psychological stability through the user's image displayed on the display screen.

In addition, the display may display visual content transmitted from the smartphone 2000.

Referring to FIG. 2 to FIG. 6, the main body 1400 may further include a main body case 1410, a water bowl 1420, a food bowl 1430, a water supply unit 1440, and a food supply unit 1450.

The main body case 1410 may be formed with a space defining portion 1411.

The space defining portion 1411 may include a food storage space 1412 containing pet food for the pet to eat, a water storage space 1413 containing water for the pet to drink, and a partition 1414 separating the food storage space 1412 from the water storage space 1413.

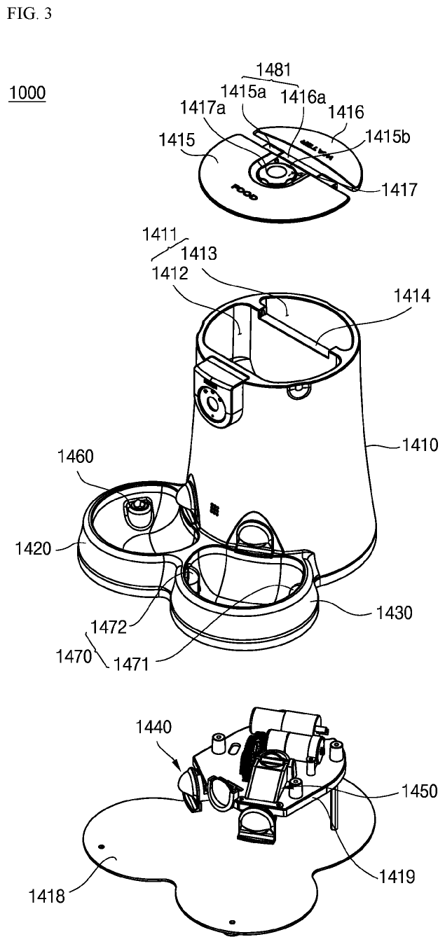

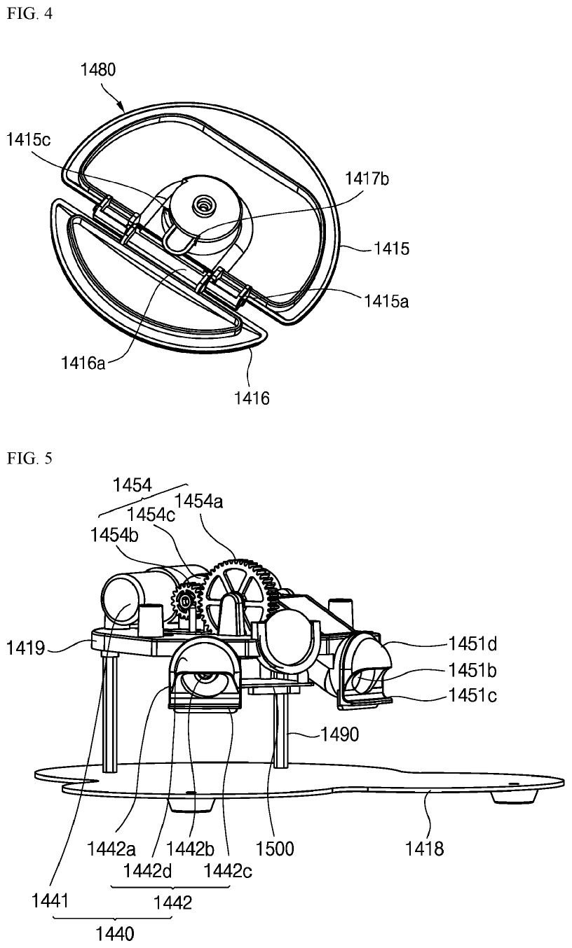

Referring to FIG. 3 and FIG. 4, the main body 1400 may further include a cover 1480 disposed on a top of the main body case 1410.

The cover 1480 may include a food storage space cover 1415 for opening/closing the food storage space 1412 and a water storage space cover 1416 for opening/closing the water storage space 1413.

The cover 1480 may further include a hinge portion 1481 to which the food storage space cover 1415 and the water storage space cover 1416 are hingedly coupled.

The hinge portion 1481 may include a first hinge portion 1415a formed at one side of the food storage space cover 1415 and a second hinge portion 1416a formed at one side of the water storage space cover 1416 and hingedly coupled to the first hinge portion 1415a.

The food storage space cover 1415 may be pivoted in one direction about the first hinge portion 1415a to open the food storage space 1412.

The water storage space cover 1416 may be pivoted about the second hinge portion 1416a in a direction opposite the pivoting direction of the food storage space cover 1415 to open the water storage space 1413.

In addition, the cover 1480 may further include a stopper member 1417 restricting opening of the water storage space cover 1416.

The stopper member 1417 may include a stopper body 1417a and a stopper protrusion 1417b.

The stopper body 1417a may be seated on a seating groove 1415b recessed in the food storage space cover 1415 and may be rotatably disposed through the food storage space cover 1415.

The seating groove 1415b is formed with a through-hole 1415c through which the stopper body 1417a passes.

The stopper protrusion 1417b may protrude from a lower region of the stopper body 1417a in an outward radial direction of the stopper body 1417a.

Specifically, the stopper protrusion 1417b may be formed in the lower region of the stopper body 1417a, which passes through the through-hole 1415c.

When the stopper protrusion 1417b is positioned under the second hinge portion 1416a due to rotation of the stopper body 1417a, the water storage space cover 1416 is prevented from being opened due to interference caused by physical contact between the stopper protrusion 1417b and the second hinge portion 1416a.

Here, a cross-section of the second hinge portion 1416a may be asymmetrical with respect to the center of rotation.

As a result, even when the pet knocks the pet care device 1000 over, the stopper member 1417 can prevent the water storage space cover 1416 from being opened, thus preventing water from spilling out of the water storage space 1413.

When the stopper protrusion 1417b is moved away from under the second hinge portion 1416a, the water storage space cover 1416 can be freely opened.

The main body 1400 may further include a base plate 1418 coupled to a lower end of the main body case 1410, a mounting plate 1419 disposed at a distance above the base plate 1418, and a support leg 1490 connecting the base plate 1418 to the mounting plate 1419.

The food supply unit 1450 and the water supply unit 1440 may be disposed on the mounting plate 1419. Here, the food supply unit 1450 may be positioned above the food bowl with respect to the base plate 1418 and the water supply unit 1440 may be positioned above the water bowl with respect to the base plate 1418.

Placement of the food supply unit 1450 above the food bowl 1430 facilitates movement of the pet food from the food storage space 1412 to the food bowl 1430. Similarly, placement of the water supply unit 1440 above the water bowl 1420 facilitates movement of water from the water storage space 1413 to the water bowl 1420.

The water bowl 1420 may be disposed at one side of the main body case 1410 and may be integrally formed with the main body case 1410.

Here, the water bowl 1420 may be filled with water discharged from the water storage space 1413.

The food bowl 1430 may be disposed at one side of the main body case 1410 and may be integrally formed with the main body case 1410.

Here, the food bowl 1420 may be filled with the pet food discharged from the food storage space 1413.

That is, according to one embodiment of the present invention, the main body case 1410 is integrally formed with the food bowl 1430 and the water bowl 1420, thereby making the device compact. Further, the cost of producing a mold for the device can be minimized.

The water supply unit 1440 is disposed under the space defining portion 1411 to supply water from the water storage space 1413 to the water bowl 1420.

The food supply unit 1450 is disposed under the space defining portion 1411 to supply the pet food from the food storage space 1412 to the food bowl 1430.

Referring to FIG. 5, the water supply unit 1440 may be disposed inside the main body case 1410.

The water supply unit 1440 supplies water from the water storage space 1413 to the water bowl 1420 through operation of a water supply pump 1441 disposed inside the main body case 1410.

Although not shown in the drawings, the water supply unit 1440 may include a first water supply connection pipe (not shown) connecting one end of the water supply pump 1441 and the water storage space 1413 and a second water supply connection pipe (not shown) connecting the other end of the water supply pump to a water supply port 1442b.

The water supply unit 1440 may further include a water supply port unit 1442 connected to the water supply pump 1441.

The water supply port unit 1442 may include a port housing 1442a, the water supply port 1442b, a first guide 1442c and a scattering prevention member 1442d.

The port housing 1442a may be disposed below the mounting plate 1419 and above the water bowl 1420.

The water supply port 1442b may be disposed on an inner wall of the port housing 1442a to allow water supplied by the water supply pump 1441 to be discharged therethrough.

The first guide 1442c may be disposed in a lower region of the port housing 1442a to guide the water discharged through the water supply port 1442b to the water bowl 1420.

The scattering prevention member 1442d may be disposed around at least a portion of the water supply port 1442b to prevent the water discharged through the water supply port 1442b from scattering.

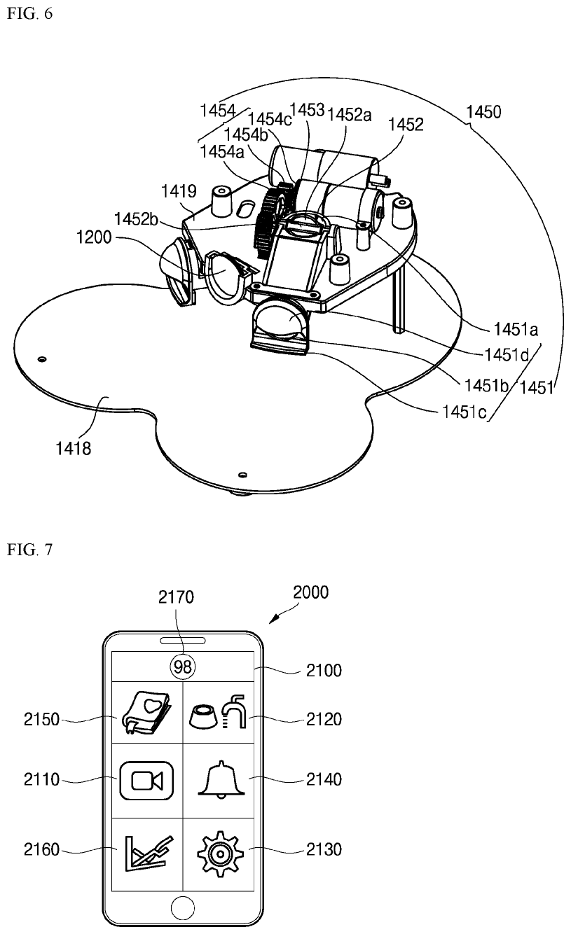

Referring to FIG. 6, the food supply unit 1450 may be disposed inside the main body case 1410 to supply the pet food from the food storage space 1412 to the food bowl 1430.

The food supply unit 1450 may be disposed on the mounting plate 1419 separated a predetermined distance from the base plate 1418.

The food supply unit 1450 may include a food guide portion 1451 and a food transfer member 1452 and a rotation drive unit 1454.

The food guide portion 1451 may be disposed between the food storage space 1412 and the food bowl 1430 to be inclined downward.

Here, the food guide portion 1451 may be provided at one side thereof with an inlet 1451a connected to the food storage space 1412 to allow the pet food from the food storage space 1412 to be introduced into the food guide portion 1451 therethrough.

In addition, the food guide portion 1451 may be provided at the other side thereof with an outlet 1415b connected to the food bowl 1430 to allow the pet food introduced into the food guide portion 1451 through the inlet 1451a to be discharged to the food bowl 1430 therethrough.

That is, the pet food from the food storage space 1412 is introduced into the food guide portion 1451 through the inlet 1451a, is then moved to the outlet 1415b along the food guide portion 1451, and is then delivered to the food bowl 1430 through the outlet 1451.

Since the food guide portion 1451 is inclined downward, the pet food from the food storage space 1412 can be smoothly moved to the food bowl 1430 along the food guide portion 1451.

In one embodiment, the food guide portion 1451 may further include a second guide 1451c disposed under the outlet 1415b to guide the pet food discharged through the outlet 1415b to the food bowl 1430.

The food guide portion 1451 may further include a splash prevention member 1451d disposed over the outlet 1415b to prevent the pet food moved toward the food bowl 1430 from splashing outwards.

The food transfer member 1452 serves to move the pet food from the food storage space 1412 to the food bowl 1430.

The food transfer member 1452 may include a shaft 1452b coupled to the rotation drive unit 1454 and multiple rotary vanes 1452a coupled to the shaft 1452b to move the pet food introduced through the inlet 1451a through rotation thereof.

The food supply unit 1450 may further include an elastic member 1453 covering an edge of each of the multiple rotary vanes 1452a to protect the multiple rotary vanes 1452a.

The elastic member 1453 protects the multiple rotary vanes 1452a from pet food introduced through a gap between an inner peripheral surface of the inlet 1451a and the multiple rotary vanes 1452a.

Specifically, the elastic member 1453 acts as a buffer to prevent damage to the rotary vanes 1452a due to hard pet food sandwiched between the inner peripheral surface of the inlet 1451a and tips of the multiple rotary vanes 1452a.

The rotation drive unit 1454 may be connected to the food transfer member 1452 to rotate the food transfer member 1452.

The rotation drive unit 1454 may include a first gear 1454a, a second gear 1454b, and a drive motor 1454c.

The first gear 1454a is connected to the shaft 1452b to rotate the shaft 1452b, which, in turn, rotates the multiple rotary vanes 1452a.

The second gear 1454b is geared with the first gear 1454a to rotate the first gear 1454a through rotation of the second gear 1454b.

The drive motor 1454c is shaft-coupled to the second gear 1454b to apply torque to second gear 1454b to rotate the second gear 1454b

That is, upon operating the drive motor 1454c, the second gear 1454b is rotated and, in turn, rotates the first gear 1454a.

As the food transfer member 1452 is rotated by rotation of the first gear 1454a, the pet food introduced through the inlet 1451a is moved on the food guide portion 1451 by the multiple rotary vanes 1452a.

In one embodiment, the pet care device 1000 may further include a first sensor 1460 and a second sensor 1470.

The first sensor 1460 is disposed in the water bowl 1420 to detect a water level in the water bowl 1420. Here, the first sensor 1460 may include a level sensor.

That is, when the water bowl 1420 is filled with water from the water storage space 1413 to a predetermined level, the controller stops operation of the water supply pump 1441 in response to detection signals from the first sensor 1460, thereby cutting off supply of water to the water bowl 1420.

The second sensor 1470 is disposed in the food bowl 1430 to detect a pet food level in the food bowl 1430. Here, the second sensor 1470 may include an optical sensor.

The second sensor 1470 may include a light-emitting portion 1471 and a light-receiving portion 1472.

That is, when light emitted from the light-emitting portion 1471 is not received by the light-receiving portion 1472 during supply of the pet food from the food storage space 1412 to the food bowl 1430, the controller stops operation of the rotation drive unit 1454 based on determination that the food bowl 1420 has been filled with the pet food to a predetermined level.

The main board 1500 may be electrically connected to the IP camera 1100, the speaker 1200, the microphone 1300, the display, the food supply unit 1450, the water supply unit 1440, and each of the sensors 1460, 1470.

The main board 1500 may include the controller and the communication unit.

Upon receiving a control signal from the smartphone 2000, the communication unit transmits the control signal to the controller.

The controller controls the components of the pet care device based on the control signal.

For example, upon receiving a signal containing a user's image or a user's voice from the smartphone 2000, the controller controls the display or the speaker 1200 to output the user's image or the user's voice.

In addition, upon receiving a signal containing feeding/watering-related information from the smartphone 2000, the controller operates the water supply unit 1440 and the food supply unit 1450.

Here, the controller controls operation of the water supply unit 1440 and the food supply unit 1450 in response to detection signals from the first sensor 1460 disposed in the water bowl 1420 and from the second sensor 1470 disposed in the food bowl 1430.

Further, upon receiving a control signal requesting sound data of the pet from the smartphone 2000, the controller operates the microphone 1300.

Although not shown in the drawings, the communication unit may wirelessly communicate with the pet care device 1000 and the user's smartphone 2000 via Wi-Fi in the building.

Here, the communication unit may receive various control signals for controlling the pet care device 1000 from the smartphone 2000 or may transmit information acquired by the controller to the smartphone 2000.

In addition, the communication unit may wirelessly communicate with the management server 3000.

The communication unit may transmit information acquired by the controller to the management server 3000.

That is, the control unit may acquire status information related to the pet, and the communication unit may transmit the acquired status information to the management server 3000.

The smartphone 2000 may display the status information while wirelessly communicating with the pet care device 1000 such that a user can check a status of the pet.

In addition, the smartphone 2000 may control the pet care device 1000 based on input information from a user.

Although the smartphone 2000 is used to control the pet care device 1000 in this embodiment, it will be understood that the present invention is not limited thereto and various other communication devices including tablet computers, personal digital assistants (PDAs), laptops, desktops, and wearable devices such as smartwatches may be used to control the pet care device 1000.

That is, the smartphone 2000 may remotely control the pet care device 1000 while wirelessly communicating with the pet care device 1000.

For example, when a user is away from home for a long time, leaving the pet alone, the user may remotely control the pet care device 1000 via the smartphone 2000.

Accordingly, the pet can gain emotional stability while the user is away.

The smartphone 2000 may include a microprocessor in which a care application 2100 for controlling the pet care device 1000 is embedded.

The care application 2100 displays care information received from the management server 3000 and the status information received from the pet care device 1000 on the smartphone 2000.

Here, the care information may include information for feeding/watering the pet, and the status information may include information about barking and movement of the pet.

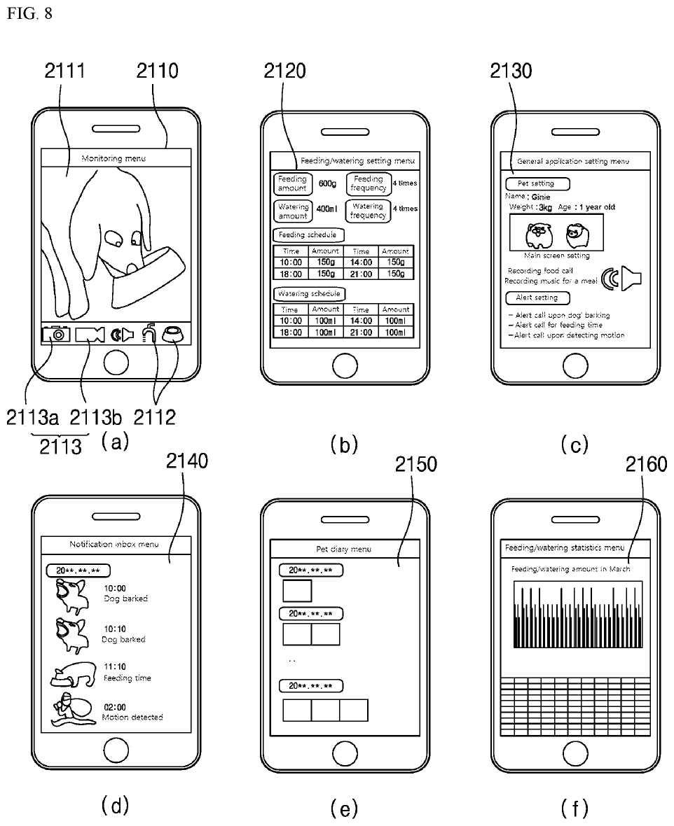

Referring to FIG. 7 and FIG. 8, the care application 2100 may include a monitoring menu 2110, a feeding/watering setting menu 2120, a general application setting menu 2130, and a notification inbox menu 2140.

The monitoring menu 2110 is a menu for viewing images of the pet. The monitoring menu 2110 may include a video call menu 2111, an arbitrary feeding/watering menu 2112, and an image view menu 2113.

A user may make a video call with the pet using the video call menu 2111.

Here, the controller operates the display, the speaker 1200, and the microphone 1300 based on a video call menu-related control signal transmitted from the smartphone 2000, thereby allowing a video call between a user and the pet.

While viewing images of the pet, a user may arbitrarily feed or water the pet using the arbitrary feeding/watering menu.

That is, although feeding/watering amounts and times for the pet may be set in advance, a user may input a control signal for arbitrarily feeding or watering the pet to the smartphone using the arbitrary feeding/watering menu based on the images of the pet.

Specifically, when a user inputs a control signal for controlling the food supply unit or the water supply unit using the arbitrary feeding/watering menu 2112, the controller of the pet care device controls the food supply unit 1450 or the water supply unit 1440 to feed or water the pet.

The image view menu 2113 is provided only for viewing images of the pet and may include a photographing menu 2113a and a video-shooting menu 2113b.

While viewing images of the pet, a user may take a photograph of the pet and store the photograph in the smartphone 2000 using the photographing menu 2113a.

In addition, while viewing images of the pet, a user may shoot a video of the pet and store the video in the smartphone 2000 using the video-shooting menu 2113b.

Here, the controller operates the IP camera 1100 based on signals related to the photographing menu 2113a and the video-shooting menu 2113b, which are transmitted from the smartphone 2000 to the communication unit, thereby allowing photographing or videoing of the pet through the IP camera 1100.

A user may set feeding/watering amounts and times for the pet in advance using the feeding/watering setting menu 2120.

That is, when a user selects the feeding/watering setting menu 2120 on the care application 2100 and inputs information related to the feeding/watering amounts and times, the smartphone 2000 transmits control signals related to the feeding/watering amounts and times to the pet care device 1000.

Then, the controller of the pet care device 1000 operates the food supply unit 1450 or the water supply unit 1440 at a preset time based on the control signals received from the smartphone 2000.

For example, a user may set daily feeding/watering amounts and daily feeding/watering frequencies using the feeding/watering setting menu 2112. In addition, a user may set a daily feeding/watering schedule based on the daily feeding/watering amounts and the daily feeding/watering frequencies.

A user may set a status of the care application 2100 using the general application setting menu 2130.

Specifically, a user may select the general application setting menu 2130 on the care application 2100 to perform synchronization between the pet care device 1000 and the smartphone 2000 and account registration.

In addition, a user may set ID information, such as name, weight, and age of the pet, using the general application setting menu 2130.

Further, a user may set an alert using the general application setting menu 2130. For example, a user may set an alert such that an alert message pops up on the smartphone screen when the pet continues to bark for a certain period of time using the general application setting menu 2130.

In addition, a user may store a notification signal for notifying the user of arrival of a preset feeding time using the general application setting menu 2130.

A user may view the care information or the status information using the notification inbox menu 2140.

For example, a user can view the status information including barking of the pet and movement of an intruder using the notification inbox menu 2140. In addition, a user may view the care information for feeding/watering the pet using the notification inbox menu 2140.

The status information received from the pet care device 1000 may include a barking interval, a barking frequency, and a movement frequency of the pet.

The care information received from the management server 3000 may include a safety index 2170 that quantifies a degree of safety of the pet based on the status information. Here, the safety index 2170 may be displayed on the care application 2100.

Accordingly, a user can immediately ascertain the degree of safety of the pet based on the safety index 2170 displayed on the care application 2100 upon operating the care application 2100.

The safety index may be a value obtained by quantifying a psychological condition of the pet based on a daily barking interval, a daily barking frequency, and a daily movement frequency of the pet.

In one embodiment, the care application 2100 may further include a pet diary menu 2150 and a feeding/watering statistics menu 2160.

The pet diary menu 2150 may be provided to keep a pet diary in the form of at least one of a photograph and a video based on the status information.

The feeding/watering statistics menu 2160 may di splay feeding/watering-related statistical data over a certain period of time.

For example, when a user selects the feeding/watering statistics menu 2160, the amounts of pet food and water ingested by the pet for a month may be displayed in graphs and tables.

As such, the care application 2100 operated via the smartphone 2000 can allow a user to monitor the pet to check the status of the pet, to store a monitored video, and to keep the pet diary through photographing.

In addition, the care application 2100 allows a video or audio call between the pet and a user, thereby providing psychological stability to the pet.

Further, the care application 2100 can allows a user to feed or water the pet in an arbitrary manner or according to a preset feeding/watering schedule.

The management server 3000 is electronically connected to the pet care device 1000 and the smartphone 2000 to transmit the care information for caring for the pet to the smartphone 2000 based on the status information received from the pet care device 1000 and preset setting information.

Here, the management server 3000 may include a cloud-based server, without being limited thereto.

That is, the management server 3000 may register the IP camera 1100 therein and may store data related to the status information of the pet received from the IP camera 1100 while transmitting the data to the smartphone 2000.

In addition, the management server 3000 may store image data related to movements of a moving object other than the pet, such as an intruder, captured by the IP camera 1100, while transmitting the image data to the smartphone 2000.

The management server 3000 may be linked with a Google or Apple notification server to transmit a notification related to the status information of the pet to the smartphone 2000 via the Google or Apple server.

Although the present invention has been described with reference to some embodiments in conjunction with the accompanying drawings, it should be understood that the foregoing embodiments are provided for illustration only and are not to be in any way construed as limiting the present invention, and that various modifications, changes, alterations, and equivalent embodiments can be made by those skilled in the art without departing from the spirit and scope of the invention.

### INDUSTRIAL APPLICABILITY

The smart pet care system according to the present invention can control feeding/watering operations through wireless communication between a smartphone and a pet care device, whereby, when a user is absent in a building in which a pet resides, the user can feed/water the pet through remote control over feeding/watering operations. Thus, the smart pet care system according to the present invention can be widely used in industry.

What is claimed is:

1. A smart pet care system comprising:
a pet care device disposed inside a building to feed and water a pet and to transmit status information related to the pet to an external device via wireless communication;
a smartphone wirelessly communicating with the pet care device to control the pet care device based on input information from a user and to display the status information such that the user checks a status of the pet; and
a management server electronically connected to the pet care device and the smartphone to transmit care information for caring for the pet to the smartphone based on the status information received from the pet care device and preset setting information.

2. The smart pet care system according to claim 1, wherein the smartphone comprises a microprocessor in which a care application for controlling the pet care device is embedded, the care application comprising a monitoring menu for viewing images of the pet, a feeding/watering setting menu for setting feeding/watering amounts and times in advance, a general application setting menu for setting the care application, and a notification inbox menu for displaying the care information or the status information.

3. The smart pet care system according to claim 2, wherein the monitoring menu comprises: a video call menu for making a video call with the pet; and an arbitrary feeding/watering menu for inputting a signal for feeding or watering the pet based on the images of the pet.

4. The smart pet care system according to claim 1, wherein the care information comprises a safety index quantifying a degree of safety of the pet based on the status information.

5. The smart pet care system according to claim 2, wherein the care application further comprises a pet diary menu for keeping a pet diary in the form of at least one of a photograph and a video based on the status information and a feeding/watering statistics menu for displaying feeding/watering-related statistical data over a certain period of time.

6. The smart pet care system according to claim 1, wherein the pet care device comprises:
an IP camera acquiring image information comprising images related to the pet;
a microphone acquiring sound information comprising sounds of the pet;
a speaker outputting a user's voice received from the smartphone; and
a main body provided with the IP camera, the microphone, and the speaker.

7. The smart pet care system according to claim 6, wherein the main body comprises:
a main body case having a space defining portion defining a food storage space containing pet food and a water storage space partitioned from the food storage space and containing water;
a water bowl integrally formed with the main body case and filled with the water discharged from the water storage space;
a food bowl integrally formed with the main body case and filled with the pet food discharged from the food storage space;
a water supply unit disposed under the space defining portion to supply the water from the water storage space to the water bowl; and
a food supply unit disposed under the space defining portion to supply the pet food from the food storage space to the food bowl.

8. The smart pet care system according to claim 7, wherein the food supply unit comprises:
a food guide portion disposed between the food storage space and the food bowl to be inclined downward;
a food transfer member moving the pet food introduced into the food guide portion to the food bowl; and
a rotation drive unit rotating the food transfer member.

9. The smart pet care system according to claim 8, wherein:
the food guide portion is formed at one side thereof with an inlet through which the pet food is introduced into the food guide portion from the food storage space and is formed at the other side thereof with an outlet through which the pet food introduced through the inlet is discharged to the food bowl; and
the food transfer member comprises a shaft coupled to the rotation drive unit and multiple rotary vanes coupled to the shaft to move the pet food introduced through the inlet through rotation thereof.

10. The smart pet care system according to claim 9, wherein the food supply unit further comprises an elastic member covering edges of the multiple rotary vanes to protect the multiple rotary vanes.

11. The smart pet care system according to claim 7, wherein the pet care device further comprises:
a first sensor disposed in the water bowl to detect a water level in the water bowl; and
a second sensor disposed in the food bowl to detect a pet food level in the food bowl.

12. The smart pet care system according to claim 7, wherein the main body further comprises: a cover disposed on a top of the main body case, the cover comprising a food storage space cover for opening/closing the food storage space, a water storage space cover for opening/closing the water storage space, a hinge portion to which the food storage space cover and the water storage space cover are hingedly coupled, and a stopper member restricting opening of the water storage space cover.

13. The smart pet care system according to claim 12, wherein:
the hinge portion comprises a first hinge portion formed at one side of the food storage space cover and a second hinge portion formed at one side of the water storage space cover and hingedly coupled to the first hinge portion; and
the stopper member comprises a stopper body rotatably disposed through the food storage space cover and a stopper protrusion protruding from a lower region of the stopper body in an outward radial direction of the stopper body.

14. The smart pet care system according to claim 13, wherein, when the stopper protrusion is positioned under the second hinge portion due to rotation of the stopper body, the water storage space cover is prevented from being opened due to interference caused by physical contact between the stopper protrusion and the second hinge portion.

15. The smart pet care system according to claim 7, wherein:
the main body further comprises: a base plate coupled to a lower end of the main body case; a mounting plate disposed at a distance above the base plate; and support legs connecting the base plate to the mounting plate; and
the food supply unit and the water supply unit are disposed on the mounting plate such that the food supply unit is positioned above the food bowl with respect to the base plate and the water supply unit is positioned above the water bowl with respect to the base plate.
